(19) United States
(12) Patent Application Publication
(10) Pub. No.: US 2012/0002175 A1
(43) Pub. Date: Jan. 5, 2012

(54) PROJECTOR AND PROJECTOR CONTROL METHOD

(75) Inventor: Shuichi Fujiwara, Azumino-shi (JP)

(73) Assignee: Seiko Epson Corporation, Tokyo (JP)

(21) Appl. No.: 13/167,866

(22) Filed: Jun. 24, 2011

(30) Foreign Application Priority Data
Jul. 1, 2010 (JP) 2010-150829

(51) Int. Cl. G03B 21/16

(52) U.S. Cl. 353/52; 353/121

(57) ABSTRACT

A projector which includes: a light source lamp; a cool down unit which performs a cool down process for the light source lamp; a mode selection unit through which a normal mode for executing the cool down process at the time of power off or a special mode for eliminating the cool down process at the time of power off is selected; and a control unit which controls the light source lamp and the cool down unit based on the result of the mode selection determined through the mode selection unit.

### CROSS-REFERENCE

The present application claims priority from Japanese Patent Application No. 2010-150829 filed on Jul. 1, 2010, which is hereby incorporated by reference in its entirety.

### BACKGROUND

A projector of a type which has a high luminance discharge lamp as a light source lamp for image projection and uses a cool down unit to cool down the light source lamp is known. This projector executes a cool down process for the light source lamp when the power is turned off (see Japanese Patent Publication No. 2007-47387).

According to this type of projector which carries out the cool down process at the time of power off, however, a time for cool down is required before the power is turned off. For example, even for the projector to be put away immediately after the end of use in most cases, the time for cool down is still required before removal of the projector. In this case, the handling convenience of the projector decreases.

For overcoming this problem, there is an option of a structure which eliminates the cool down process at the time of power off. According to this structure, however, the light source lamp does not satisfy the temperature requirement for activation when the light source lamp after turned off is again turned on before completion of sufficient cool down. In this case, lighting of the light source lamp fails. For example, when the power of the projector is often turned on without an elapse of time after power off, there is a possibility that the projector does not start operation in the normal condition or that the step of power on is again required after the light source lamp is sufficiently cooled. In this case, the degree of convenience for using the projector lowers.

Accordingly, the projector in either case of the above related arts decreases its handling convenience depending on the way of use. That is, the projector in either case is difficult to be used in various ways with high flexibility without lowering the degree of convenience for use.

### SUMMARY

Various embodiments may provide a projector usable in various ways with high flexibility without lowering its handling convenience, and to provide a method for controlling this projector.

According to at least one embodiment of the disclosure, there is provided a projector including: a light source lamp; a cool down unit which performs a cool down process for the light source lamp; a mode selection unit through which a normal mode for executing the cool down process at the time of power off or a special mode for eliminating the cool down process at the time of power off is selected; and a control unit which controls the light source lamp and the cool down unit based on the result of the mode selection determined through the mode selection unit.

According to at least one embodiment of the disclosure, there is provided a method for controlling a projector which includes a light source lamp and a cool down unit performing a cool down process for the light source lamp including: allowing selection of a normal mode for executing the cool down process at the time of power off or a special mode for eliminating the cool down process at the time of power off; and controlling the light source lamp and the cool down unit based on the result of the mode selection.

According to these configurations, the normal mode for executing the cool down process at the time of power off or the special mode for eliminating the cool down process at the time of power off can be selected. In this case, the user can determine the mode appropriate for the user's way of use. Thus, the handling convenience of the projector does not decrease. More specifically, when the “special mode” is selected, the projector can be put away immediately after the end of use of the projector. On the other hand, when the “normal mode” is selected, the projector after turned off can be turned on without an elapse of time. Thus, the projector can be used in various ways with high flexibility without lowering the degree of convenience for use.

It is preferable that the control unit of the projector of the above aspect turns on the light source lamp after completion of the cool down process allowed by the control unit and performed by the cool down unit when the light source lamp does not satisfy an activation temperature requirement at the time of power on under the condition in which the special mode is selected.

According to this configuration, the light source lamp is tuned on after completion of the cool down process when the activation temperature requirement is not satisfied. Thus, failure of turning on the light source lamp can be prevented.

In this case, it is preferable that the control unit allows the cool down unit to perform the cool down process by at least a necessary amount for satisfying the activation temperature requirement of the light source lamp at the time of power on.

According to this configuration, the cool down process is executed by at least the necessary amount for the activation temperature requirement. Thus, the cool down process can be completed by the minimum execution amount, i.e., the minimum length of the execution time.

In this case, it is preferable that the projector further includes a temperature detection unit which detects the temperature around the light source lamp, and that the control unit determines the necessary amount based on the detection result obtained from the temperature detection unit and the activation temperature requirement.

In this case, it is also preferable that the projector further includes a turned-off time measuring unit which measures the continuous turned-off time of the light source lamp, and that the control unit determines the necessary amount based on the measurement result obtained from the turned-off time measuring unit.

According to these configurations, the necessary amount of the cool down process can be accurately determined through simple constitution provided by the temperature detection unit and the turned-off time measuring unit.

In this case, it is preferable that the projector further includes an execution amount input unit through which an execution amount of the cool down process is inputted when the normal mode is selected, and that the control unit determines execution of the cool down process at the time of power off based on the input result obtained from the execution amount input unit.

According to this configuration, the user can determine and input the execution amount of the cool down process. Thus, the projector can be used in various ways with higher flexibility.

According to at least one embodiment of the disclosure, there is provided a projector including: a light source lamp, a cool down unit which performs a cool down process for the light source lamp; an execution amount selection unit through which an execution amount of the cool down process at the time of power off is selected from a plurality of predetermined execution amounts; and a control unit which controls the light source lamp and the cool down unit based on the result of the amount selection determined through the execution amount selection unit.

According to at least one embodiment of the disclosure, there is provided a method for controlling a projector which includes a light source lamp and a cool down unit performing a cool down process for the light source lamp including: allowing selection of an execution amount of the cool down process at the time of power off from a plurality of predetermined execution amounts; and controls the light source lamp and the cool down unit based on the result of the amount selection.

According to these configurations, the execution amount of the cool down process can be selected from the plural predetermined execution amounts. In this case, the user can select the execution amount appropriate for the user's way of use, wherefore the handling convenience of the projector does not decrease. That is, the projector can be used in various ways with high flexibility without lowering the degree of convenience for use. The execution amount of the cool down process herein may refer only to an execution time, or may refer to an execution time including an execution output or an execution time including an effect produced by execution of the cool down process, for example.

### BRIEF DESCRIPTION OF THE DRAWINGS

Non-limiting and non-exhaustive embodiments of the present disclosure will be described with reference to the accompanying drawings, wherein like reference numbers reference like elements.

FIG. 1 is a block diagram showing the structure of a projector according to an embodiment.

FIGS. 2A through 2D illustrate screen transitions in a setting change process under a one-touch off mode.

FIG. 3 is a flowchart showing a power off process of the projector.

FIG. 4 is a flowchart showing a power on process of the projector.

FIG. 5 is a block diagram showing the structure of a projector according to a modified example.

### DESCRIPTION OF EXEMPLARY EMBODIMENT

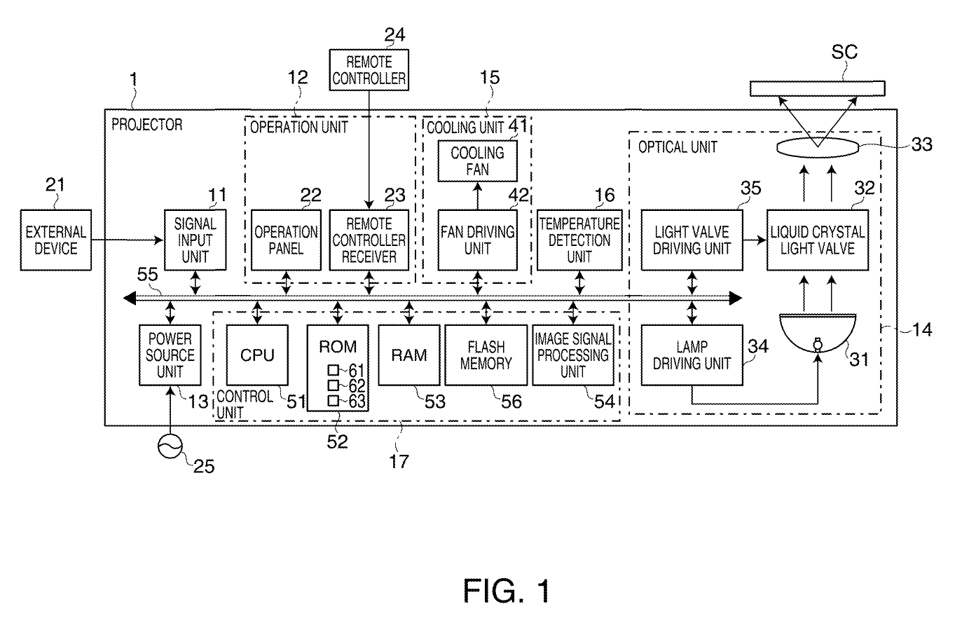

A projector and a projector control method according to an embodiment of the invention are hereinafter described with reference to the appended drawings. FIG. 1 is a block diagram showing the structure of a projector 1. As illustrated in the figure, the projector 1 includes a signal input unit 11, an operation unit 12, a power source unit 13, an optical unit 14, a cooling unit (cool down unit) 15, a temperature detection unit 16, and a control unit 17.

The signal input unit 11 obtains image data from an external device 21 such as a personal computer and a video recorder. The signal input unit 11 may acquire image data and the like from an external storage medium (not shown) instead of the external device 21.

The operation unit 12 has an operation panel 22 and a remote controller receiver 23. The operation panel 22 is provided on the main body of the projector 1, and has a group of buttons operated when various operations are performed and a group of LEDs for indicating various conditions of the projector 1. The group of buttons contains a power source button operated to turn on and off the power, and a menu button operated to display menus. The group of LEDs include an LED (condition indicator) provided to indicate that the projector 1 is in a standby condition (described later). A remote controller 24 equipped for remote control of the main body of the projector 1 has a group of various buttons similar to those of the operation panel 22. The remote controller receiver 23 receives operation signals (infrared signals) from the remote controller 24.

The power source unit 13 supplies power received from an external power source 25 to the respective components of the projector 1.

The optical unit 14 provided for image projection on a screen SC has a light source lamp 31 (light source), a liquid crystal light valve 32, a projection lens 33, a lamp driving unit 34, and a light valve driving unit 35.

The light source lamp 31 is constituted by a high luminance discharge lamp (high intensity discharge (HID) lamp) such as a high-pressure sodium lamp, a metal halide lamp, and a high-pressure mercury lamp. The liquid crystal light valve 32 is a component formed by a liquid crystal panel having a pair of transparent substrates between which liquid crystals are sealed, for example. In this case, the liquid crystal panel includes transparent electrodes as pixels disposed in matrix on the inner surfaces of the respective transparent substrates for applying driving voltage to the liquid crystals for each small area. The lamp driving unit 34 allows the light source lamp 31 to emit light in response to a lighting instruction issued from the control unit 17. The light valve driving unit 35 determines the light transmittance of each pixel of the liquid crystal light valve 32 by applying driving voltage to each pixel in accordance with image data. The optical unit 14 having this structure modulates illumination light emitted from the light source lamp 31 while the illumination light is passing through the liquid crystal light valve 32. The modulated image light is combined for each pixel by the function of a not-shown light combining system (such as dichroic prism), and projected on the screen SC through the projection lens 33.

The cooling unit 15 has a cooling fan 41 and a fan driving unit 42. The cooling fan 41 decreases the temperature of the interior of the projector 1 (particularly light source lamp 31 and surroundings thereof) by rotation of the fan. The fan driving unit 42 drives the cooling fan 41 in response to a driving instruction issued from the control unit 17. The cooling unit 15 cools the turned on light source lamp 31 to control the temperature of the light source lamp 31, and also cools the turned off light source lamp 31 to cool down the light source lamp 31. The process of “cool down” herein is a process for cooling the interior of the projector 1 (particularly light source lamp 31 and surroundings thereof) so as to satisfy particular temperature requirements (such as activation temperature requirement of light source lamp 31).

The temperature detection unit 16 detects the temperature around the light source lamp 31. The temperature detection unit 16 monitors the temperature of the light source lamp 31 based on the detection result (detection temperature) to secure the safety of the projector 1.

The control unit 17 has a CPU (central processing unit) 51, a ROM (read only memory) 52, a RAM (random access memory) 53, a flash memory 56, and an image signal processing unit 54.

The CPU 51 is a central processing unit performing various calculations, and supervises and controls the projector 1 through input and output of signals to and from the respective units via a bus 55. The ROM 52 stores control programs and control data used when the CPU 51 executes the respective calculations. The control programs include a setting change program 61, a power off program 62, and a power on program 63. The ROM 52 stores OS (operating system) as basic software. The RAM 53 constituted by a static RAM or the like is a work area used when the CPU 51 executes the respective calculations. The flash memory 56 stores setting information and the like of the projector 1 as rewritable data. The image signal processing unit 54 performs predetermined image processing for image data obtained by the signal input unit 11 under an image processing program stored in the ROM 52.

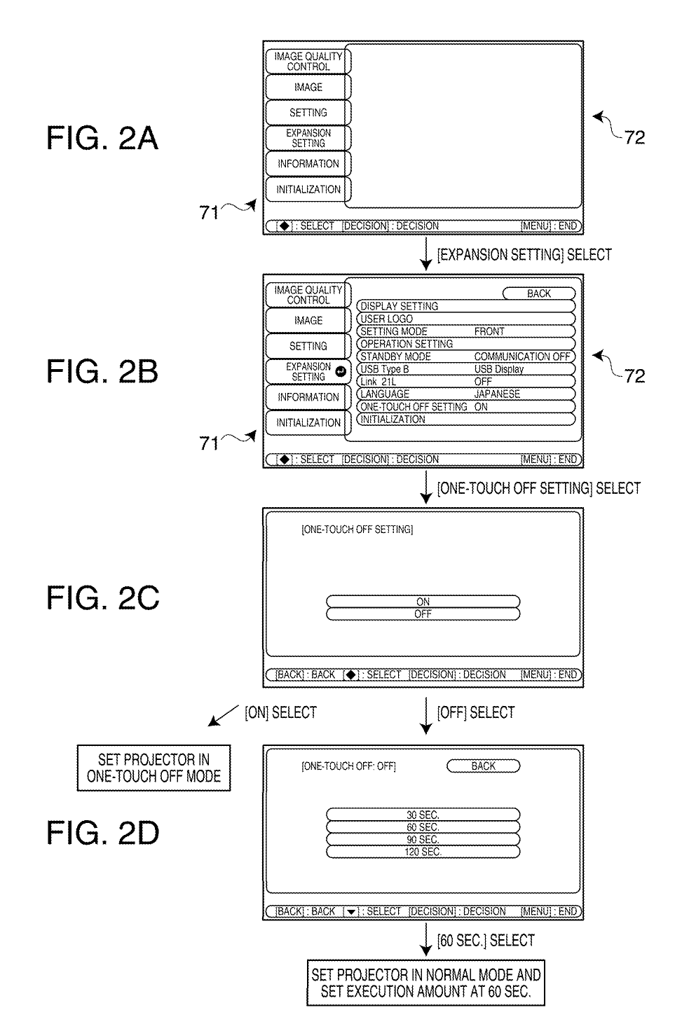

The setting change program 61 is a program which displays menu screens (see FIGS. 2A through 2D) and allows a user to change various settings of the projector 1. Particularly, the setting change program 61 permits the user to select and set “ON” or “OFF” of a one-touch off mode (special mode). The one-touch off mode is a mode for eliminating the cool down process at the time of power off. When the user selects the one-touch off mode “ON”, the control unit 17 sets the projector 1 in the one-touch off mode corresponding to the cool down “OFF” setting at the time of power off. When the user selects the one-touch off mode “OFF”, the control unit 17 sets the projector 1 in the normal mode corresponding to the cool down “ON” setting at the time of power off. In the one-touch off mode, the cool down process is performed at the time of power on only as necessary so as to prevent lighting failure caused by insufficient cooling. The details of this process will be described later. A “mode selection unit” and an “execution amount input unit” included in the appended claims are constituted by an OSD (on screen display) produced by the operation unit 12, the control unit 17, and the setting change program 61.

The power off program 62 is a program under which the power off process is executed in accordance with the setting of the one-touch off mode. The power on program 63 is a program under which the power on process of the projector 1 is executed in accordance with the setting of the one-touch off mode.

The setting change process in the one-touch off mode is now explained with reference to FIGS. 2A through 2D. This setting change process is carried out under the setting change program 61, and initiated in an active condition (after the power on process and before the power off process). The active condition corresponds to a condition in which the chief functions such as lighting of the light source lamp 31 are operating. On the other hand, the condition in which the chief functions such as lighting of the light source lamp 31 are stopping with power supplied to the projector 1 is called a standby condition.

When the user executes the menu display operation, the control unit 17 allows the optical unit 14 to display the menu screen (FIG. 2A). The menu screen contains a tab menu area 71 disposed at the left end to display a plurality of tab menus, and a sub menu area 72 extending wide on the right side of the tab menu area 71 to display lists of sub menus. In this example, the user selects the tab menu corresponding to “expansion setting” to which the one-touch off mode belongs from the plural tab menus.

When the user selects the “expansion setting”, the control unit 17 displays the lists of the sub menus corresponding to the “expansion setting” in the sub menu area 72 (FIG. 2B). In this example, the user selects “one-touch off setting” corresponding to the one-touch off mode setting from the sub menus.

When the user selects the “one-touch off setting”, the control unit 17 displays a selection screen for determining “ON” or “OFF” of the one-touch off mode (FIG. 2C). When the user selects “ON” on the selection screen, the control unit 17 sets the projector 1 in the one-touch off mode and stores this setting information in the flash memory 56. When the user selects “OFF” on the selection screen, the control unit 17 displays a selection screen for allowing the user to select the execution amount (execution time) of the cool down process at the time of power off (FIG. 2D). The execution amount is selected from options of “30 seconds”, “60 seconds”, “90 seconds”, and “120 seconds” on the selection screen. After the execution amount is selected, the control unit 17 sets the projector 1 in the normal mode, and simultaneously sets the execution amount of the cool down process at the time of power off at the selected time and stores this setting information in the flash memory 56. After completion of these steps, the setting change process ends.

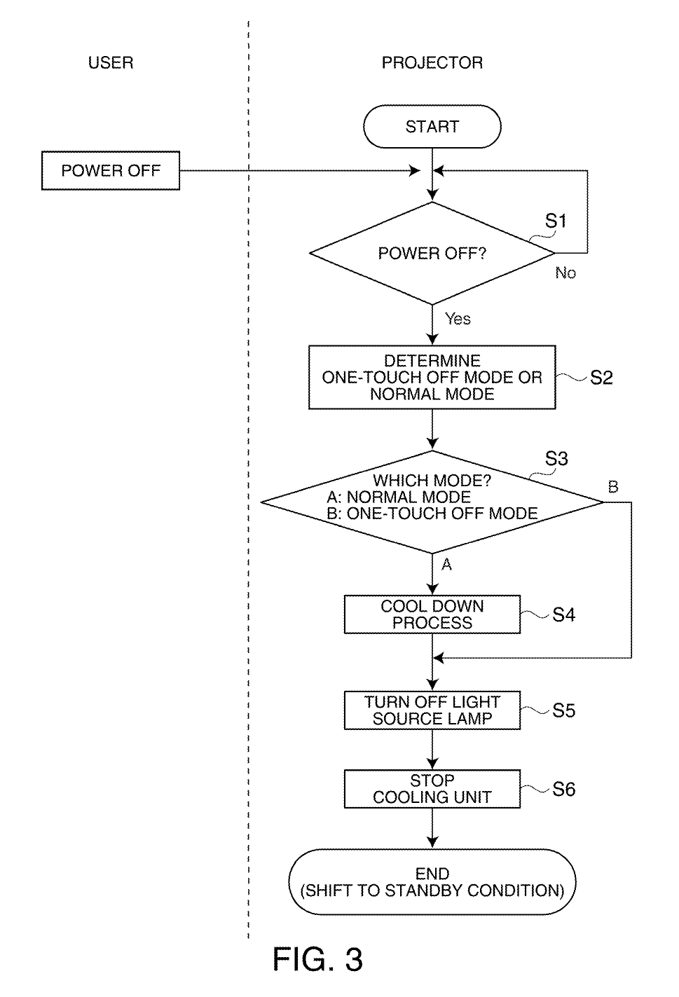

The power off process of the projector 1 is now explained with reference to FIG. 3. The power off process is performed under the power off program 62, and is initiated in response to the power off operation. This process is carried out in the active condition. Thus, the power off process is a process for transition from the active condition to the standby condition.

When the user executes the power off operation (S1: Yes) as shown in the flowchart of FIG. 3, the control unit 17 determines in which mode the projector 1 is operating (one-touch off mode or normal mode) (S2). When the projector 1 is in the normal mode (S3: A), the control unit 17 allows the cooling unit 15 to execute the cool down process by the execution amount set beforehand (S4). When the cool down process is finished, the control unit 17 turns off the power source lamp 31 (S5) and stops the operation of the cooling unit 15 (cooling fan 41) to shift to the standby condition.

When it is determined that the projector 1 is in the one-touch off mode (S3: B), the control unit 17 eliminates the step of the cool down process. That is, the control unit 17 immediately turns off the light source lamp 31 (S5) and stops the operation of the cooling unit 15 (cooling fan 41) without carrying out the cool down process (S6), and then shifts to the standby condition. After completion of these steps, the power off process ends.

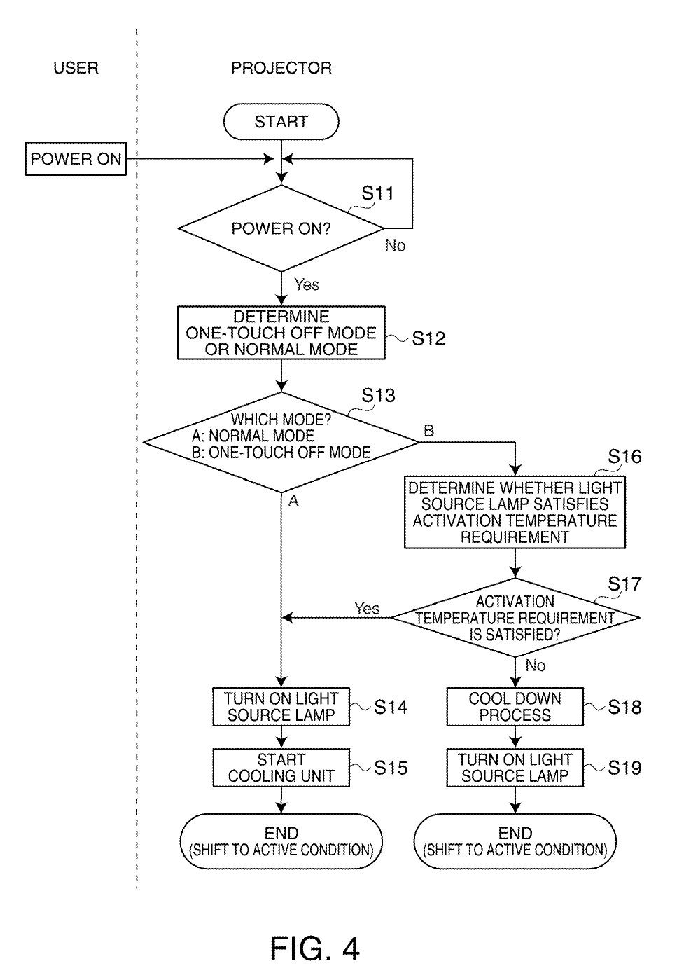

The power on process of the projector 1 is now explained with reference to FIG. 4. The power on process is performed under the power on program 63, and initiated in response to the power on operation. This process is executed in the standby condition. Thus, the power on process is a process for transition from the standby condition to the active condition.

When the user executes the power on operation as shown in the flowchart of FIG. 4 (S11: Yes), the control unit 17 determines in which mode the projector 1 is operating (one-touch off mode or normal mode) (S12). When the projector 1 is in the normal mode (S13: A), the control unit 17 turns on the light source lamp 31 (S14) and starts the operation of the cooling unit 15 (temperature control process) (S15) to shift to the active condition. When the projector 1 is in the one-touch off mode, the control unit 17 determines whether the light source lamp 31 satisfies the activation temperature requirement or not based on the detection temperature obtained by the temperature detection unit 16 (S16). More specifically, the control unit 17 determines whether the detection temperature exceeds a specified value corresponding to the activation temperature requirement (temperature corresponding to the requirement for activating the light source lamp 31).

When it is determined that the detection temperature satisfies the activation temperature requirement (the detection temperature does not exceed the specified value) (S17: Yes), the control unit 17 eliminates the step of the cool down process. That is, the control unit 17 turns on the light source lamp 31 (S14) and starts the operation of the cooling unit 15 (temperature control process) (S15) without carrying out the cooling down process, and then shifts to the active condition. When the detection temperature does not satisfy the activation temperature requirement (the detection temperature exceeds the specified value) (S17: No), the control unit 17 executes the cool down process by the necessary amount for satisfying the activation temperature requirement (S18). The necessary amount of the cool down process is determined by the detection temperature and the activation temperature requirement (more strictly, by the difference between the detection temperature and the specified value). When the cool down process ends, the control unit 17 continues the operation of the cooling unit 15 (shifts to the temperature control process) and turns on the light source lamp 31 (S19) to shift to the active condition. After completion of these steps, the power on process ends.

According to this embodiment, the cool down process “ON” mode or the cool down process “OFF” mode can be selected at the time of power off. In this case, the user is allowed to select the mode appropriate for the user's way of using the projector 1. Thus, the handling convenience of the projector 1 does not decrease. More specifically, when the “one-touch off mode” is selected, the projector 1 can be put away immediately after the finish of use. On the other hand, when the “normal mode” is selected, the projector 1 after turned off can be turned on without an elapse of time. Therefore, the projector 1 can be used in various ways with high flexibility without decreasing the degree of convenience for use.

Moreover, the cool down process at the time of power on is performed by the necessary amount for satisfying the activation temperature requirement. Thus, the cool down process can be completed by the minimum execution amount, i.e., the minimum length of the execution time.

In addition, the necessary amount of the cool down process can be accurately determined through simple constitution provided by the temperature detection unit 16.

Furthermore, the user can determine and input the execution amount of the cool down process at the time of power off in the setting change process. Thus, the projector 1 can be used in various ways with higher flexibility.

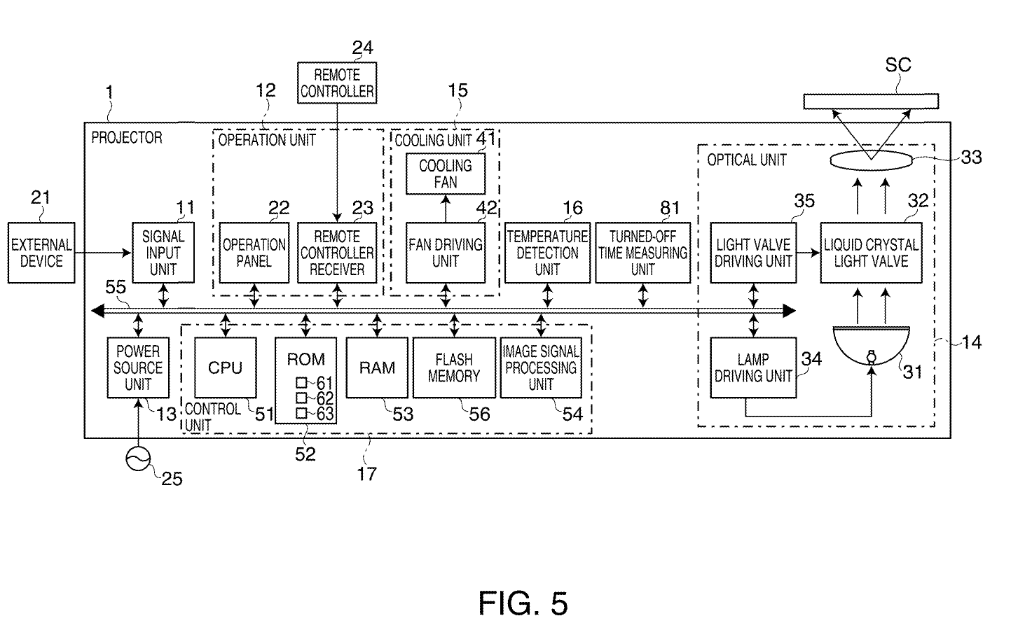

According to this embodiment, whether or not the cool down process is carried out at the time of power on and the execution amount in the one-touch off mode are determined by using the temperature detection unit 16. However, these conditions of whether or not the cool down process is carried out at the time of power on and the execution amount can be determined by using a turned-off time measuring unit 81 provided on the projector 1 as an additional unit which measures the continuous turned-off time (period from turned-off time to present time) of the light source lamp 31 as illustrated in FIG. 5. In this case, the control unit 17 eliminates the step of the cool down process at the time of power on when the measurement turned-off time (measured continuous turned-off time) obtained by the turned-off time measuring unit 81 reaches a specified value corresponding to the activation temperature requirement, and executes the cool down process for the execution time corresponding to the measurement turned-off time (the difference between the measurement turned-off time and the specified value) when the measurement turned-off time does not reach the specified value.

According to this embodiment, the execution amount of the cool down process at the time of power off is selected from two or more predetermined options of the execution amount (predetermined execution time) under the setting change program 61. However, the execution amount of the cool down process may be determined through direct input (arbitrary setting).

According to this embodiment, “ON” or “OFF” of the one-touch off mode is selected under the setting change program 61. When the selected one-touch off mode is “ON”, the execution time of the cool down process at the time of power off is further selected from two or more options of the predetermined execution amount (predetermined execution time). However, the execution time of the cool down process at the time of power off may be selected from a plurality of choices of the predetermined execution amount including “0” as a selection of “OFF” of the one-touch off mode for completing the two steps of selection in one step.

According to this embodiment, the execution amount satisfying the activation temperature requirement is determined based on the detection temperature of the temperature detection unit 16 when the activation temperature requirement is not satisfied in the one-touch off mode. However, under this situation, the cool down process may be carried out for a predetermined execution time regardless of the detection temperature.

According to this embodiment, the cool down process is performed only when the activation temperature requirement is not satisfied in the one-touch off mode. However, the cool down process may be carried out regardless of whether the activation temperature requirement is satisfied or not.

According to this embodiment, the upper limit is not established for the execution amount of the cool down process at the time of power on in the one-touch off mode. However, the upper limit of the execution amount may be determined from a selection screen.

What is claimed is:

1. A projector comprising:
a light source lamp;
a cool down unit which performs a cool down process for the light source lamp;
a mode selection unit through which a normal mode for executing the cool down process at the time of power off or a special mode for eliminating the cool down process at the time of power off is selected; and
a control unit which controls the light source lamp and the cool down unit based on the result of the mode selection determined through the mode selection unit.

2. The projector according to claim 1, wherein the control unit turns on the light source lamp after completion of the cool down process allowed by the control unit and performed by the cool down unit when the light source lamp does not satisfy an activation temperature requirement at the time of power on under the condition in which the special mode is selected.

3. The projector according to claim 2, wherein the control unit allows the cool down unit to perform the cool down process by at least a necessary amount for satisfying the activation temperature requirement of the light source lamp at the time of power on.

4. The projector according to claim 3, further comprising:
a temperature detection unit which detects the temperature around the light source lamp,
wherein the control unit determines the necessary amount based on the detection result obtained from the temperature detection unit and the activation temperature requirement.

5. The projector according to claim 3, further comprising:
a turned-off time measuring unit which measures the continuous turned-off time of the light source lamp,
wherein the control unit determines the necessary amount based on the measurement result obtained from the turned-off time measuring unit.

6. The projector according to claim 1, further comprising:
an execution amount input unit through which an execution amount of the cool down process is inputted when the normal mode is selected,
wherein the control unit determines execution of the cool down process at the time of power off based on the input result obtained from the execution amount input unit.

7. A method for controlling a projector which includes a light source lamp and a cool down unit performing a cool down process for the light source lamp, comprising:
allowing selection of a normal mode for executing the cool down process at the time of power off or a special mode for eliminating the cool down process at the time of power off; and
controlling the light source lamp and the cool down unit based on the result of the mode selection.

8. The method according to claim 7, further comprising:
turning on the light source lamp after completion of the cool down process performed by the cool down unit when the light source lamp does not satisfy an activation temperature requirement at the time of power on under the condition in which the special mode is selected.

9. The method according to claim 8, further comprising:
allowing the cool down unit to perform the cool down process by at least a necessary amount for satisfying the activation temperature requirement of the light source lamp at the time of power on.

10. The method according to claim 9, further comprising:
detecting the temperature around the light source lamp, and
determining the necessary amount based on the detected temperature and the activation temperature requirement.

11. The method according to claim 9, further comprising:
measuring the continuous turned-off time of the light source lamp, and
determining the necessary amount based on the measured continuous turned-off time.

12. The method according to claim 7, further comprising:
receiving an execution amount of the cool down process when the normal mode is selected, and
determining execution of the cool down process at the time of power off based on the received execution amount of the cool down process.
